(19) United States
(12) Patent Application Publication
(10) Pub. No.: US 2026/0111464 A1
(43) Pub. Date: Apr. 23, 2026

(54) AGENT-BASED METHOD FOR GENERATING CORPUS DATA, AGENT, DEVICE, AND MEDIUM

(71) Applicant: BEIJING BAIDU NETCOM SCIENCE TECHNOLOGY CO., LTD., Beijing (CN)

(72) Inventors: Yiqing WU, Beijing (CN); Chunguang CHAI, Beijing (CN); Xiaopeng CUI, Beijing (CN); Hong ZHU, Beijing (CN); Liping OUYANG, Beijing (CN); Yuzhen ZHAO, Beijing (CN)

(21) Appl. No.: 19/425,100

(22) Filed: Dec. 18, 2025

(30) Foreign Application Priority Data
Sep. 22, 2025 (CN) 202511355262.4

(51) Int. Cl. G06F 16/3329; G06F 40/169; G06F 40/30; G06Q 10/0631

(52) U.S. Cl. CPC G06F 16/33295; G06F 40/169; G06F 40/30; G06Q 10/06316

(57) ABSTRACT

An agent-based method for generating corpus data, an agent, a device, and a medium are provided which relate to the field of artificial intelligence technology, and in particular to the fields of deep learning, large models, and intelligent question answering technologies. The agent-based method for generating corpus data includes: acquiring a target task rule related to a page to be processed, where a semantic dependency relationship in the target task rule represents a semantic understanding logic among a plurality of item components in the page to be processed; executing a target task for the plurality of item components based on the semantic dependency relationship by using a designated agent according to the target task rule, and outputting an item response information; and generating target corpus data according to the item response information and item contents in the item components.

### CROSS-REFERENCE TO RELATED APPLICATION(S)

This application claims the benefit of Chinese Patent Application No. 202511355262.4 filed on Sep. 22, 2025, the whole disclosure of which is incorporated herein by reference.

### TECHNICAL FIELD

The present disclosure relates to the field of artificial intelligence technology, and in particular to the fields of deep learning, large models, and intelligent question answering technologies.

### BACKGROUND

An agent is a core concept in the field of artificial intelligence, which may be a system capable of perceiving an environment, making autonomous decisions, and taking actions to achieve a goal. An agent may convert theoretical reasoning of a large model into practical actions through tool invocation.

### SUMMARY

The present disclosure provides an agent-based method for generating corpus data, an agent, an electronic device, and a storage medium.

According to an aspect of the present disclosure, an agent-based method for generating corpus data is provided, including: acquiring a target task rule related to a page to be processed, where a semantic dependency relationship in the target task rule represents a semantic understanding logic among a plurality of item components in the page to be processed; executing a target task for the plurality of item components based on the semantic dependency relationship by using a designated agent according to the target task rule, and outputting an item response information; and generating target corpus data according to the item response information and item contents in the item components.

According to another aspect of the present disclosure, an artificial intelligence agent is provided, which is configured to perform the method provided in embodiments of the present disclosure.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to perform the method provided in embodiments of the present disclosure.

According to another aspect of the present disclosure, a non-transitory computer-readable storage medium having computer instructions therein is provided, where the computer instructions are configured to cause a computer to perform the method provided in embodiments of the present disclosure.

It should be understood that the content described in this section is not intended to identify key or essential features of embodiments of the present disclosure, nor is it intended to limit the scope of the present disclosure. Other features of the present disclosure will become easily understood through the following description.

### BRIEF DESCRIPTION OF THE DRAWINGS

The accompanying drawings are provided to facilitate a better understanding of the present disclosure and do not constitute limitations to the present disclosure. In the accompanying drawings:

FIG. 1 schematically shows an exemplary system architecture to which an agent-based method and apparatus for generating corpus data may be applied according to embodiments of the present disclosure;

FIG. 2 schematically shows a flowchart of an agent-based method for generating corpus data according to embodiments of the present disclosure;

FIG. 3 schematically shows a principle diagram of a semantic dependency relationship according to embodiments of the present disclosure;

FIG. 4 schematically shows a principle diagram of the agent-based method for generating corpus data according to embodiments of the present disclosure;

FIG. 5 schematically shows a block diagram of an agent-based apparatus for generating corpus data according to embodiments of the present disclosure;

FIG. 6 schematically shows a structural block diagram of an artificial intelligence agent according to embodiments of the present disclosure; and

FIG. 7 shows a schematic block diagram of an exemplary electronic device that may be used to implement the agent-based method for generating corpus data according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In the technical solutions of the present disclosure, the acquisition, storage, and application of user personal information all comply with relevant laws and regulations, adopt necessary confidentiality measures, and do not violate public order and good customs.

The inventors found that users may generate corpus data for a specified task by responding to content displayed in page components. For example, a user may input an answer to a question information displayed in a page component to generate question-answer pair corpus data for training a language model. However, the efficiency of generating corpus data is low, and the data quality of the corpus data generated by a generative model processing the page content is not high, making it difficult to meet actual task requirements.

Embodiments of the present disclosure provide an agent-based method and apparatus for generating corpus data, an agent, an electronic device, and a storage medium. The agent-based method for generating corpus data includes: acquiring a target task rule related to a page to be processed, where a semantic dependency relationship in the target task rule represents a semantic understanding logic among a plurality of item components in the page to be processed; executing a target task for the plurality of item components based on the semantic dependency relationship by using a designated agent according to the target task rule, and outputting an item response information; and generating target corpus data according to the item response information and item contents in the item components.

According to embodiments of the present disclosure, the target task rule is acquired, and the designated agent is prompted to perform semantic understanding on the plurality of item components in the page to be processed according to the semantic understanding logic indicated by the semantic dependency relationship among the plurality of item components in the target task rule and execute the target task for responding to the item components. This allows the item response information to avoid hallucinations caused by erroneous semantic understanding logic between the item components, thereby improving the data quality of the output item response information. Consequently, based on the item response information and the item content, target corpus data that accurately represents the response of a professional to the item components in the page to be processed may be generated. This avoids corpus defects such as semantic logic confusion and mismatch between response content and requirements in the target corpus data, and reduces the interactive operation process required by personnel to generate the target corpus by interacting with the page to be processed, thereby improving the generation efficiency of the target corpus data.

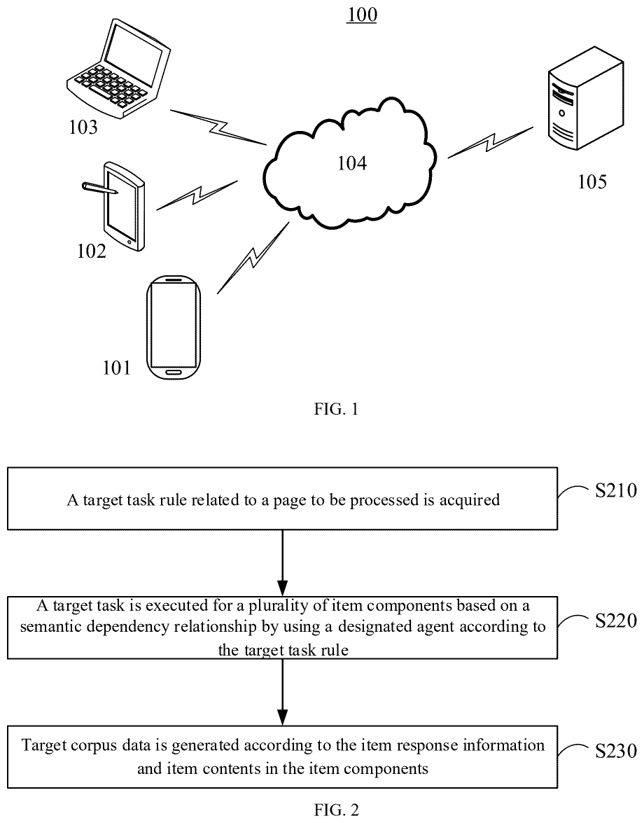

FIG. 1 schematically shows an exemplary system architecture to which the agent-based method and apparatus for generating corpus data may be applied according to embodiments of the present disclosure.

It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments, or scenarios. For example, in another embodiment, the exemplary system architecture to which the agent-based method and apparatus for generating corpus data may be applied may include a terminal device, but the terminal device may implement the agent-based method and apparatus for generating corpus data provided in embodiments of the present disclosure without interacting with a server.

As shown in FIG. 1, a system architecture 100 according to this embodiment may include a first terminal device 101, a second terminal device 102, a third terminal device 103, a network 104, and a server 105. The network 104 serves as a medium for providing a communication link between the first terminal device 101, the second terminal device 102, the third terminal device 103, and the server 105. The network 104 may include various types of connections, such as wired and/or wireless communication links.

The first terminal device 101, the second terminal device 102, and the third terminal device 103 may be used by a user to interact with the server 105 through the network 104 to receive or send messages, etc. The first terminal device 101, the second terminal device 102, and the third terminal device 103 may be installed with various communication client applications, such as knowledge reading applications, web browser applications, search applications, instant messaging tools, email clients, and/or social platform software, etc. (merely as examples).

The first terminal device 101, the second terminal device 102, and the third terminal device 103 may be various electronic devices having display screens and supporting web browsing, including but not limited to smart phones, tablet computers, laptop computers, and desktop computers, etc.

The server 105 may be a server providing various services, such as a background management server (merely as an example) that provides support for content browsed by the user using the first terminal device 101, the second terminal device 102, and the third terminal device 103. The background management server may analyze and process received data such as a user request, and return a processing result (such as a web page, information, or data acquired or generated according to the user request) to the terminal devices.

The server 105 may be a cloud server, also known as a cloud computing server or cloud host, which is a host product in a cloud computing service system to solve shortcomings of difficult management and poor service scalability existing in traditional physical hosts and VPS (Virtual Private Server) services. The server 105 may also be a server of a distributed system, or a server integrated with block-chain.

It should be noted that the agent-based method for generating corpus data provided in embodiments of the present disclosure may generally be performed by the first terminal device 101, the second terminal device 102, or the third terminal device 103. Accordingly, the agent-based apparatus for generating corpus data provided in embodiments of the present disclosure may be disposed in the first terminal device 101, the second terminal device 102, or the third terminal device 103.

Alternatively, the agent-based method for generating corpus data provided in embodiments of the present disclosure may be performed by the server 105. Accordingly, the agent-based apparatus for generating corpus data provided in embodiments of the present disclosure may be disposed in the server 105. The agent-based method for generating corpus data provided in embodiments of the present disclosure may also be performed by a server or server cluster different from the server 105 and capable of communicating with the first terminal device 101, the second terminal device 102, the third terminal device 103, and/or the server 105. Accordingly, the agent-based apparatus for generating corpus data provided in embodiments of the present disclosure may be disposed in a server or server cluster different from the server 105 and capable of communicating with the first terminal device 101, the second terminal device 102, the third terminal device 103, and/or the server 105.

It should be understood that the number of terminal devices, networks, and servers shown in FIG. 1 is merely illustrative. According to implementation needs, any number of terminal devices, networks, and servers may be provided.

FIG. 2 schematically shows a flowchart of an agent-based method for generating corpus data according to embodiments of the present disclosure.

As shown in FIG. 2, the agent-based method for generating corpus data includes operation S210 to operation S230.

In operation S210, a target task rule related to a page to be processed is acquired.

In operation S220, a target task is executed for a plurality of item components based on a semantic dependency relationship by using a designated agent according to the target task rule, and an item response information is output.

In operation S230, target corpus data is generated according to the item response information and item contents in the item components.

According to embodiments of the present disclosure, the page to be processed may include one or more item components, which may be page components that record item content. The item content in the item component represents a specific requirement intent. For example, the item content may be a question content “Please write a response text that answers the question ‘Is the quality of this product good?’”.

In some embodiments, the item content may further include content that constrains the response information in terms of format, word count, style, or other requirement conditions. For example, the item content may further include “The response needs to be in the tone of an electronics professional and less than 30 words.”

According to embodiments of the present disclosure, the target task rule may be a response requirement rule used to prompt the designated agent to perform semantic understanding on the item content in the item component.

In some embodiments, the target task rule may include a structured information representing a semantic text of the response requirement rule in the item content. For example, the target task rule may include “<30 words” and “Tone style: electronics professional”.

In some embodiments, the target task rule may further include content that expresses the response requirement rule for the item component in a guidance document or training document. The guidance document or training document may include any file related to the item component, such as text document, video, speech information, or the like. For example, if the text in the guidance document is “The response needs to be provided in conjunction with professional technical terms for electronic devices”, the requirement condition in the target task rule may be “Response style: output the response text based on technical terms for electronic devices”.

In some embodiments, the target task rule may further include a semantic dependency relationship. The semantic dependency relationship in the target task rule represents a semantic understanding logic among a plurality of item components in the page to be processed. The semantic dependency relationship may be used to indicate a reading order of the plurality of item components in the page to be processed and an answering order of the plurality of item components.

In some embodiments, the semantic dependency relationship may further indicate other item content and response content that need to be considered or understood when responding to a designated item component. For example, the semantic dependency relationship may indicate that “The response to the item content of item component C needs to be generated in combination with the respective response texts for item A and item B”.

For another example, the semantic dependency relationship in the target task rule may include a semantic dependency prompt text “The item theme content of items 1 to 3 on the first page is: the theme content of item 1”, which is output by performing semantic understanding on an item guidance text “The three item components in the first page share a common item theme content” in a filling specification manual.

According to embodiments of the present disclosure, by executing the target task for responding to the item content of the plurality of item components using the designated agent according to the semantic dependency relationship and the response requirement rule in the target task rule, the designated agent may accurately perform semantic understanding on the item contents of the plurality of item components according to the semantic dependency relationship, thereby avoiding deviations in semantic understanding. Furthermore, the designated agent may execute the target task based on the response requirement rule for responding to the item components, so that the output item response information may satisfy the response requirement intent of the item components. This helps avoid hallucinations of the designated agent that may otherwise degrade the response quality, thereby improving the generation quality and generation efficiency of the item response information, and ensuring the degree of semantic matching between the item response information and the requirement intent of the item content as well as the response requirement rule.

According to embodiments of the present disclosure, the designated agent may execute the target task and output the item response information by invoking a large model.

For example, the designated agent may send the target task rule and the item contents of the item components to a model end where a language large model is deployed. The language large model at the model end may perform accurate semantic understanding on the target task rule and the item contents, and output designated tool resources to be invoked and execution parameters corresponding to the designated tool resources. The model end may invoke the designated tool resources to execute tool tasks according to the execution parameters, and receive tool execution results. The model end may perform semantic understanding on the tool execution results of multiple tools to output the item response information. The designated agent may then receive the item response information and record the item response information into the item component by controlling a designated page filling tool.

In some embodiments, the target corpus data may include training corpus for training a designated language large model. For example, question-answer pair corpus for specific scenarios or specific requirements may be generated as target corpus data based on the item content representing a questioning text and the item response information representing an answering text.

In some embodiments, the target corpus data may further include evaluator training corpus for personnel such as teachers who evaluate the professional level of a designated user. By using the designated agent to generate target corpus data that simulates a trainee answering the item components in the page to be processed, it is possible to quickly and efficiently generate corpus content that matches an incorrect answering condition indicated in the requirement condition. This allows the evaluators to grade examples in the target corpus data to improve the evaluation level of the evaluators.

In some embodiments, the target corpus data may be any type of corpus content. For example, the target corpus data may include presentation slides, program code files, script files, or any other type of corpus content. The specific type of the target corpus data is not limited in embodiments of the present disclosure.

In some embodiments, the item component includes a page component related to at least one selected from: judgment item, selection item, ranking item, and text generation item.

According to embodiments of the present disclosure, a judgment item may be an item that requires making a “yes” or “no” judgement on the item content. The designated agent may perform semantic understanding on the item content of a judgment item component according to the target task rule and output an item response information representing “yes” or “no”. The item response information may be, for example, a “√” symbol representing “yes”, or the item response information may be generated by performing a selection operation on an item option representing “yes” in the judgment item component.

According to embodiments of the present disclosure, a selection item may be an item that requires selecting content from a plurality of options in the item content. The designated agent may perform semantic understanding on the item content of a selection item component according to the target task rule and output data indicating the selected option content as the item response information.

According to embodiments of the present disclosure, a ranking item may be an item that requires determining an order of arrangement for a plurality of contents to be ranked in the item content. For example, the item content in a ranking item component may include a plurality of example response texts, and the item requirement content of the ranking item component is to rank the plurality of example response texts according to their quality levels.

According to embodiments of the present disclosure, a text generation item may be an item that requires generating a response text based on the requirement intent represented by the item content. For example, the item content in a text generation item component may be “Generate a summary text of the following news content”, and the item response information may be a text content representing the summary of the news content.

It should be noted that the item type represented in the item component is not limited in embodiments of the present disclosure, and may be selected or designed based on actual requirements.

In some embodiments, the target task rule may be determined by: performing semantic understanding on the response requirement information to obtain a response requirement condition; and performing semantic fusion, by using a large model, on the response requirement condition and the respective item contents of the plurality of item components to obtain the target task rule including a semantic dependency relationship.

According to embodiments of the present disclosure, the response requirement information is used to describe the requirement intent for responding to the item components. For example, the requirement intent may be a word count limit intent, output format intent, reading order prompt intent, etc. for the item response information.

According to embodiments of the present disclosure, the response requirement condition may be represented based on any type of data, such as text, tables, topological diagrams, and the like.

For example, the response requirement condition may be a requirement intent related to a field requirement attribute of the item response information, such as a word count range of the item response information, or whether blank fields in a fill-in-the-blank item is “required”or “optional”.

For another example, the response requirement condition may be an output format intent for the item response information, such as paragraph format, list format, dialogue format, and other requirement intent.

In some embodiments, the response requirement condition may further include a rule condition that describes an execution dependency relationship among the plurality of item components. For example, the response requirement condition may be expressed in any format of data such as text or topological diagrams to indicate that fill-in-the-blank item components AB and AC need to be completed before executing item component A. For another example, the response requirement condition may indicate semantically fusing the response content of item component A and the response content of item component B to generate a new response text.

In some embodiments, the response requirement condition may be determined by performing semantic understanding, using a large model, on the response requirement information and the item contents of the plurality of item components in the page to be processed. Accordingly, the powerful semantic understanding and text generation capabilities of the large model may be utilized to improve the representation accuracy of the requirement intent with respect to the requirement attribute represented by the response requirement information.

In some embodiments, the response requirement condition representing the requirement intent may be obtained by performing a text extraction on requirement keywords of the item content of the item component using keyword extraction, optical character recognition, or other algorithms.

In some embodiments, performing semantic understanding on the response requirement information to obtain the response requirement condition includes: performing a text extraction on the item contents of the plurality of item components in the page to be processed and on the guidance document related to the response requirement of the page to be processed, so as to obtain the response requirement condition represented by keywords.

For example, a text recognition service resource may be invoked for a screenshot of a page region corresponding to the item components to identify the title, prompt text, and other item content in the item components, thereby obtaining a response requirement condition represented by text. The response requirement condition may indicate an understanding order of the title content and annotation content in the item content, so that the response requirement condition prompts the designated agent to understand layout positions and semantic understanding sequence of the plurality of item components in the page to be processed.

For another example, a character count limit condition for the item component may be determined by reading a character limit attribute parameter of the option content in the item component.

In some embodiments, the response requirement condition may be determined by performing a text recognition on the response requirement information such as requirement documents and training videos, and extracting text and structured information from the recognized text. For example, for a page to be processed for annotating corpus data, the response requirement condition may be determined by extracting annotation item attributes, annotation business background, annotation target requirement information, annotation time nodes, item component names, item component function descriptions, and input/output specifications for item response information from the item components by using natural language understanding technologies such as syntactic parsing, entity recognition, and relationship extraction.

For another example, an Automatic Speech Recognition (ASR) service may be invoked to convert a speech in screen recording into text to generate a transcribed text with timestamp. By extracting key frames from the training video and identifying video frame transition points using image hashing or slide image matching algorithms, paragraph content in the transcribed text may be aligned with the content of the training slides, thereby obtaining a semantically aligned response requirement condition.

In some embodiments, performing semantic fusion, by using a large model, on the response requirement condition and the respective item contents of the plurality of item components may include: using the response requirement condition as a prompt information to enable the large model to understand and fuse respective textual semantics of the plurality of item components, so that the large model may understand the item response rule that the item response information output for the item component needs to satisfy. Meanwhile, based on the semantic understanding capability of the large model, a latent requirement condition indicated in the response requirement information, such as guidance documents, may be converted into an explicit requirement rule. Combined with the item content semantics of the plurality of item components, a semantic logic relationship that satisfies responses to the item content may be output. Accordingly, the target task rule, which includes the item response rule and the semantic logic relationship, may accurately prompt the designated agent to quickly and accurately understand the plurality of item components in the page to be processed, thereby avoiding semantic understanding errors, improving the quality of the item response information, and enhancing the quality of the target corpus data.

In some embodiments, the semantic dependency relationship is represented based on an execution path. The execution path may indicate a positional order of reading the plurality of item contents distributed in the page to be processed, or the execution path may indicate an execution order of executing the target task for the plurality of item components distributed in the page to be processed.

In some embodiments, performing semantic fusion, by using a large model, on the response requirement condition and the respective item contents of the plurality of item components may further include: performing semantic fusion, by using the large model, on the response requirement condition, the respective item contents of the plurality of item components, and a positional relationship among the plurality of item contents, so as to obtain the semantic dependency relationship.

According to embodiments of the present disclosure, the positional relationship is determined based on a page layout of the plurality of item contents in the page to be processed. The page layout of the plurality of item contents may include respective page positions of the plurality of item contents in the page to be processed. The page positions of the item contents in the page to be processed may be determined based on component attribute information related to the item contents in the item components. The positional relationship may include any data representing relative positions, such as distances and directions between different item contents.

In some embodiments, the semantic dependency relationship may indicate a reading path for a plurality of question paragraph contents distributed at different positions in the page to be processed, whether such contents belong to the same item component or different item components.

For example, in an example, the positional relationship among the plurality of item contents may be expressed as: item content A and item content B are arranged vertically in the left column of the page, and item content C and item content D are arranged vertically in the right column of the page. Through semantic fusion performed by the large model on the response requirement condition, the text contents of the plurality of item contents, and the positional relationship of the plurality of item contents, a semantic dependency relationship may be determined to indicate: semantic understanding is performed in a semantic understanding sequence of “first paragraph content A in the left column, second paragraph content B in the left column, first paragraph content C in the right column, second paragraph content D in the right column” to output the item response information. This controls the designated agent to accurately perform semantic understanding on the item contents at the corresponding positions according to the reading order of the plurality of item contents indicated by the semantic dependency relationship to execute the target task, and prevents the designated agent from merely reading the item text sequentially from left to right across the page to be processed to execute the target task. This improves the accuracy of the item response information, reduces occurrences of semantic hallucination of the designated agent, and enhances the overall quality and generation efficiency of the target corpus data.

In some embodiments, the response requirement information may further include a negative example text for responding to the item components and a defect description information for the negative example text. For example, the negative example text may include item contents and incorrect response information with a large number of errors, or examples of easily confusing information formats. The defect description information may include editors' correction content and explanations of error causes for the incorrect response information example.

In some embodiments, the response requirement condition may further include condition content that matches the requirement intent such as word count requirement condition, paragraph count requirement condition, tone style condition, and the like, which is output by performing semantic understanding and statistical analysis, using a large model, on the information indicating the adoption of the response information, such as word count, paragraph count, tone style description, and other information in the correction content output by the editors.

According to embodiments of the present disclosure, by performing semantic understanding using the large model on the item content, the negative example text, and the defect description information for the negative example text, the large model may be prompted to accurately understand the output content containing defects, so as to summarize the target task rule that may accurately represent the requirement intent. Consequently, the designated agent may accurately respond to the item components according to the target task rule and generate item response information that satisfies the response requirement information, thereby improving the quality of the item response information.

In some embodiments, the semantic dependency relationship and the item requirement rule in the target task rule may be stored hierarchically according to attribute types such as item type and priority of the item components, so as to facilitate the designated agent.

In some embodiments, executing the target task for the plurality of item components based on the semantic dependency relationship by using the designated agent according to the target task rule may include: performing task orchestration on a target item component based on the semantic dependency relationship by using the designated agent to obtain a content understanding path; performing semantic understanding on the plurality of target item contents based on the content understanding path by using the designated agent according to the item response rule in the target task rule, and outputting the item response information related to the target item component.

According to embodiments of the present disclosure, the content understanding path represents a semantic understanding sequence for a plurality of target item contents related to the target item component. The content understanding path may include a plurality of semantic understanding tasks having an execution dependency relationship. The designated agent may execute the semantic understanding tasks by invoking a language large model to obtain a plurality of execution results, and determine the item response information according to the plurality of execution results.

For example, the content understanding path may be represented based on a path topology. The path topology includes a plurality of path nodes having edge relationships. A path node includes information such as a page position and a sequence identifier related to the target item content of the target item component. According to the path nodes and edge relationships related to the content understanding path, the designated agent may execute a plurality of semantic understanding tasks based on the semantic logic relationship among the plurality of target item contents. Consequently, by simulating a reading behavior of a human responder with respect to the plurality of target item contents in the page to be processed, it avoids confusions in the semantic logic relationship that may otherwise cause the designated agent to output the item response information that fails to satisfy the requirements of the plurality of target item contents.

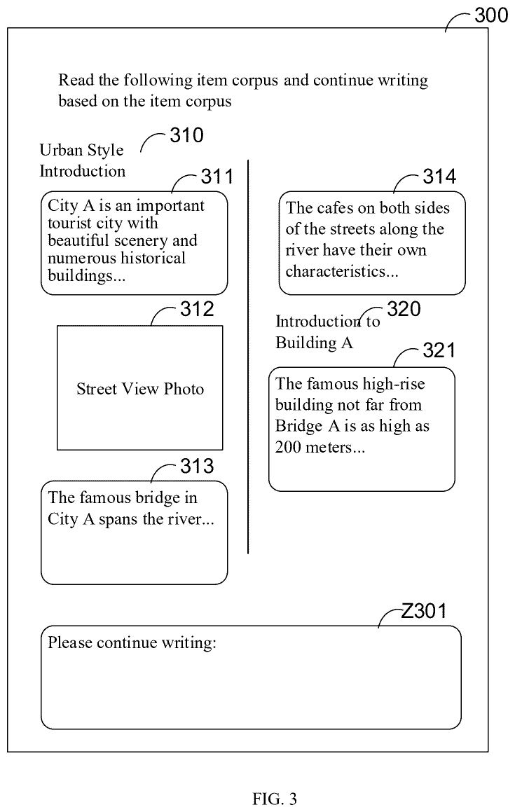

FIG. 3 schematically shows a principle diagram of a semantic dependency relationship according to embodiments of the present disclosure.

As shown in FIG. 3, a first item component 300 includes item contents in left and right columns. The item requirement condition “Read the following item corpus and continue writing based on the item corpus” is presented at the top of the left and right columns in the first item component 300. The semantic dependency relationship may prompt the designated agent to read according to the layout positions of a first theme 310, a first text content 311, a street view photo 312, a second text content 313, a third text content 314, a second theme 320, and a fourth text content 321 in the first item component 300. Accordingly, based on the semantic dependency relationship, the designated agent may read according to the semantic order of the layout positions corresponding to the plurality of item contents, thereby avoiding semantic understanding contradictions or hallucinations that may arise if the first item component is read sequentially from left to right. The designated agent may execute the target task by understanding the plurality of item contents in the first item component 300 according to the semantic dependency relationship to output a continuation text as the item response information. The continuation text may be filled in a response box Z301.

Thus, the semantic dependency relationship may instruct the designated agent to understand the plurality of item contents in the item component having a complex layout according to the semantic logic. The designated agent may execute the target task according to a plurality of layout positions and the reading order of the layout positions indicated by the semantic dependency relationship, thereby improving the corpus quality of the item response information and enhancing the data quality of the target corpus data.

In some embodiments, performing semantic understanding on the plurality of target item contents based on the content understanding path by using the designated agent according to the response requirement condition in the target task rule may include: executing a semantic understanding task on a first target content among the plurality of target item contents based on the content understanding path by using the designated agent, and outputting a first execution result; and performing semantic understanding on a second target content associated with the first target content based on the content understanding path by using the designated agent according to the first execution result, and outputting a second execution result.

According to embodiments of the present disclosure, the first target content and the second target content may be item contents in different item components. Alternatively, the first target content and the second target content may be item contents in the same item component. The mapping relationship between the plurality of target contents and the item components is not limited in embodiments of the present disclosure.

According to embodiments of the present disclosure, the item response information is determined based on the first execution result and the second execution result. The second target content may have a semantic dependency relationship with the first target content. By performing semantic understanding on the second target content according to the first execution result, the designated agent may learn the second target content according to the semantic understanding sequence indicated by the content understanding path. By executing a semantic understanding task on the first execution result required for responding to the second target content as indicated by the item requirement rule, the designated agent may quickly identify the input data required for responding to the first target content. This avoids the omission of important input data for the semantic understanding task, which would otherwise cause logical confusion or unclear expression in the item response information, thereby improving the quality of the item response information.

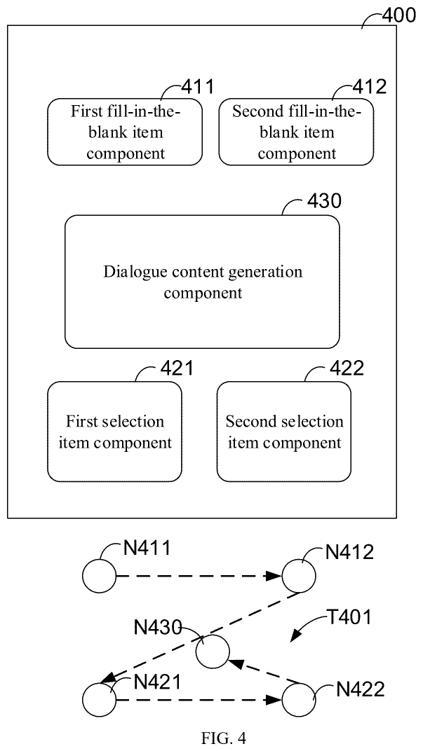

FIG. 4 schematically shows a principle diagram of the agent-based method for generating corpus data according to embodiments of the present disclosure.

As shown in FIG. 4, a plurality of target item components are distributed in a page to be processed 400. The plurality of target item components include a first fill-in-the-blank item component 411, a second fill-in-the-blank item component 412, a dialogue content generation component 430, a first selection item component 421, and a second selection item component 422. By performing task orchestration on the item contents of the plurality of target item components and the semantic logic sequence of the plurality of item contents indicated by the semantic dependency relationship using the designated agent, a content understanding path including a plurality of semantic understanding tasks may be obtained. The content understanding path may be represented by a path topology T401. For example, the first fill-in-the-blank item component 411, the second fill-in-the-blank item component 412, the dialogue content generation component 430, the first selection item component 421, and the second selection item component 422 correspond to a first path node N411, a second path node N412, a third path node N430, a fourth path node N421, and a fifth path node N422, respectively. The positions of the plurality of path nodes in the path topology T401 represent layout positions of the target item components in the page to be processed 400, and the edge relationship among the path nodes may represent a semantic understanding sequence of the item contents in the plurality of target item components.

Thus, the designated agent may perform task orchestration on the target item contents in the plurality of target item components according to the content understanding path represented by the path topology T401 to obtain a plurality of semantic understanding tasks having an execution dependency relationship. The designated agent may invoke one or more designated language large models to execute the plurality of semantic understanding tasks according to the execution dependency relationship and output a plurality of execution results. Accordingly, the language large model may first execute a semantic understanding task for responding to the first fill-in-the-blank item component 411 and the second fill-in-the-blank item component 412 to obtain a fill-in-the-blank response information as a 1^{st} first execution result. Then, according to the execution dependency relationship, the language large model may execute a semantic understanding task for selecting options in the first selection item component 421 and the second selection item component 422 to obtain a selection item response information containing target options as a 2^{nd} first execution result. The language large model may further execute a semantic understanding task by processing the fill-in-the-blank response information, the selection item response information, and the dialogue content in the dialogue content generation component 430 to output a dialogue generation text as a second execution result. Consequently, target corpus data for training a large model to be trained may be generated based on the dialogue generation text, the fill-in-the-blank response information, the selection item response information, and the target item contents of the plurality of target item components. The large model trained using the target corpus data may then be applied to designated scenarios to engage in dialogue with users to meet user needs.

According to embodiments of the present disclosure, by performing task orchestration on the target item content using the designated agent according to the semantic dependency relationship in the target task rule, the content understanding path may accurately represent the plurality of semantic understanding tasks that need to be executed, and the layout positions and semantic understanding sequence of the plurality of target item components in the page to be processed may be explicitly indicated by the content understanding path. Thus, based on the content understanding path, the language large model may be scheduled to execute the plurality of semantic understanding tasks in the content understanding path, thereby responding to the plurality of item components according to the target task rule, improving the matching degree between the item response information and the requirement intent of the target object, and further improving the data quality of the target corpus data.

In some embodiments, the agent-based method for generating corpus data may further include: in response to an interactive operation performed on a first response information in the item response information, updating the first response information to obtain an updated first response information; determining a second response information associated with the first response information from the plurality of item response information based on the semantic dependency relationship; and updating the second response information according to the updated first response information to obtain an updated second response information.

According to embodiments of the present disclosure, the interactive operation performed on the first response information may be an operation used to modify a response content in the first response information. For example, it may include editing operations such as deleting or replacing text characters of the first response information. For another example, it may include an interactive operation for changing the selected target option for the first response information to obtain an updated target option.

According to embodiments of the present disclosure, the associated first response information and second response information may include item response information respectively corresponding to the first item component and the second item component that have a semantic dependency relationship. Updating the second response information according to the updated first response information may include performing an update operation, such as deletion or replacement, on the second response information based on a modification content carried by the interactive operation, so that a plurality of associated item response information that have already been generated may be automatically modified according to the interactive operation.

For example, if “Area A” in the first response information is modified to “Region A” by the target object, the “Area A” in a 1^{st} second response information associated with the first response information may be modified according to the updated first response information containing “Region A” to obtain a second response information containing “Region A”, and “Area B” in a 2^{nd} second response information may be updated to obtain a second response information containing “Region B”.

In some embodiments, the second response information may also be updated by performing semantic understanding on the updated first response information using the designated agent, so that the second response information maintains the same semantic logic relationship and style consistency as the first response information, thereby avoiding semantic contradictions.

For example, if the updated first response information is a colloquial dialogue text expressed based on an arbitrary target style attribute, such as a dialect style, the style attribute of the second response information may be updated by the designated agent performing semantic understanding on the updated first response information, thereby outputting a dialogue text expressed in the same target style attribute as the first response information, such as a dialect style.

According to embodiments of the present disclosure, by updating the second response information semantically associated with the first response information using the updated first response information, automated batch updating of the item response information that needs to be modified may be achieved according to the interactive operation of the target object, thereby improving the modification efficiency for the item response information. Accordingly, target corpus data may be generated based on the updated first response information, the updated second response information, and the respective item contents of the updated first response information and the updated second response information, thereby improving the generation efficiency of the target corpus data. Furthermore, this prevents the target object from overlooking the interactive operation to update the second response information semantically associated with the first response information, which may otherwise cause the second response information to fail to meet the actual requirements of the target object, thereby enhancing the quality of the target corpus data by improving the quality of the item response information.

In some embodiments, the method provided in embodiments of the present disclosure may be performed in an offline batch mode. For example, the method provided in embodiments of the present disclosure may be performed during a designated time period such as nighttime to generate a large amount of target corpus data, thereby achieving a flexible use of computing resources and improving resource utilization efficiency.

In some embodiments, generating the target corpus data according to the item response information and the item contents in the item components includes: annotating the item corpus in the item content based on an evaluation response information to obtain first target corpus data; and annotating the text response information based on a text requirement content in the text generation item component to obtain second target corpus data.

According to embodiments of the present disclosure, the target corpus data includes first target corpus data and second target corpus data. The item response information may include an evaluation response information and a text response information.

In some embodiments, the evaluation response information refers to content that evaluates the item corpus that needs to be evaluated in the item content.

For example, the evaluation response information may be a grading attribute for evaluating the item corpus, and the grading attribute may include “Excellent”, “Good”, “Unqualified”, etc.

For another example, the evaluation response information may be a text content that evaluates the item corpus, such as “The logic of the response text is not coherent”.

According to embodiments of the present disclosure, by annotating the item corpus using the evaluation response information as annotation data for the item corpus, the first target corpus data may include associated item corpus and evaluation response information. A language large model to be trained may learn using the evaluation response information, which is provided by the designated agent for evaluating the item corpus, as prompts, so that the text generation capability or text evaluation capability of the language large model to be trained may be improved.

In some embodiments, the text response information may be a response text generated by the designated agent performing semantic understanding on the target task rule and the text requirement content.

For example, if the text requirement content is: “Compose a poem on the theme of the moon”, the text response information may be a poem text on the theme of the moon generated by the designated agent executing the target task based on the target task rule and the text requirement content.

According to embodiments of the present disclosure, by annotating the text response information using the text requirement content as the annotation data for the text response information, the second target corpus data may include associated text requirement content and text response information. A language large model to be trained may learn using the text requirement content as prompts to enhance its ability to generate text for diverse requirement contents. Accordingly, the method provided in embodiments of the present disclosure enables a rapid and convenient generation of target corpus data for training language large models, thereby improving the training efficiency for the language large model and enhancing the adaptability of the trained language large model to specific requirements in various scenarios.

In some embodiments, the agent-based method for generating corpus data provided in embodiments of the present disclosure may further include checking or verifying the target task rule and the item response information that have already been generated, so that the target task rule and the item response information may be promptly corrected according to verification results, thereby improving the quality of the item response information. The types of verification may include integrity verification, rule matching verification, consistency verification, etc., for the target task rule and the item response information.

The integrity verification is used to verify whether the item response information has been generated for each item component in the page to be processed, ensuring no omissions. For cases where the item component includes multi-turn dialogue item content or long text item content, the verification checks whether the item response information contains defects such as content coherence defects or missing content defects.

The rule matching verification is used to verify the accuracy and necessity of the item requirement rule in the target task rule, such as field format rule, template rule, required field rule, character length rule, and information structured format rule, so as to avoid errors in the rules that may otherwise cause the designated agent to output item response information that does not comply with the requirement intent.

The consistency verification is used to verify whether elements such as item component identifier, paragraph identifier of the item content, technical terms, and reference relationships represented in the semantic dependency relationship in the target task rule meet the semantic logic requirements, so as to prompt manual intervention in a timely manner to correct the semantic dependency relationship.

For the target task rule and item response information that fail the verification, the designated agent may be automatically prompted to re-respond to the item component to generate a new item response information. Alternatively, the target task rule and the item response information may be processed by relevant personnel through interactive operations. The history record of each verification and retest is recorded for subsequent quality analysis and rule optimization for the target corpus data and the designated agent.

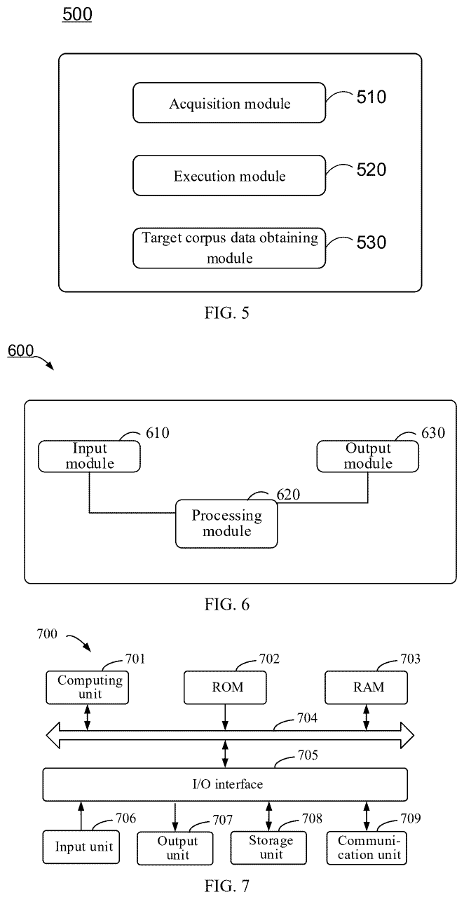

FIG. 5 schematically shows a block diagram of an agent-based apparatus for generating corpus data according to embodiments of the present disclosure.

As shown in FIG. 5, an agent-based apparatus 500 for generating corpus data includes an acquisition module 510, an execution module 520, and a target corpus data obtaining module 530.

The acquisition module 510 is configured to acquire a target task rule related to a page to be processed, where a semantic dependency relationship in the target task rule represents a semantic understanding logic among a plurality of item components in the page to be processed.

The execution module 520 is configured to execute a target task for the plurality of item components based on the semantic dependency relationship by using a designated agent according to the target task rule, and output an item response information.

The target corpus data obtaining module 530 is configured to generate target corpus data according to the item response information and item contents in the item components.

According to embodiments of the present disclosure, the target task rule is determined by: performing semantic understanding on a response requirement information to obtain a response requirement condition, where the response requirement information describes a requirement intent for responding to the item components; and performing semantic fusion, by using a large model, on the response requirement condition and the respective item contents of the plurality of item components, to obtain the target task rule including the semantic dependency relationship.

According to embodiments of the present disclosure, performing semantic fusion, by using a large model, on the response requirement condition and the respective item contents of the plurality of item components includes: performing semantic fusion, by using the large model, on the response requirement condition, the respective item contents of the plurality of item components, and a positional relationship among the plurality of item contents, to obtain the semantic dependency relationship, where the positional relationship is determined based on a page layout of the plurality of item contents in the page to be processed.

According to embodiments of the present disclosure, according to the target task rule, the execution module includes a content understanding path obtaining unit and an item response information obtaining unit.

The content understanding path obtaining unit is configured to perform task orchestration on a target item component based on the semantic dependency relationship by using the designated agent to obtain a content understanding path, where the content understanding path represents a semantic understanding sequence for a plurality of target item contents related to the target item component.

The item response information obtaining unit is configured to perform semantic understanding on the plurality of target item contents based on the content understanding path by using the designated agent according to an item response rule in the target task rule, and output an item response information related to the target item component.

According to embodiments of the present disclosure, the item response information obtaining unit includes a first output subunit and a second output subunit.

The first output subunit is configured to execute a semantic understanding task for a first target content among the plurality of target item contents based on the content understanding path by using the designated agent, and output a first execution result.

The second output subunit is configured to perform semantic understanding on a second target content associated with the first target content based on the content understanding path by using the designated agent according to the first execution result, and output a second execution result, where the item response information is determined based on the first execution result and the second execution result.

According to embodiments of the present disclosure, the target corpus data obtaining module includes a first obtaining unit and a second obtaining unit.

The first obtaining unit is configured to annotate item corpus in the item content based on an evaluation response information to obtain first target corpus data.

The second obtaining unit is configured to annotate a text response information based on a text requirement content in a text generation item component to obtain second target corpus data.

According to embodiments of the present disclosure, the agent-based apparatus for generating corpus data further includes a first update module, a second response information determination module, and a second update module.

The first update module is configured to, in response to an interactive operation performed on a first response information in the item response information, update the first response information to obtain an updated first response information.

The second response information determination module is configured to determine a second response information associated with the first response information from a plurality of item response information based on the semantic dependency relationship.

The second update module is configured to update the second response information according to the updated first response information to obtain an updated second response information.

According to embodiments of the present disclosure, the item component includes a page component related to at least one selected from: judgment item, selection item, ranking item, or text generation item.

FIG. 6 schematically shows a structural block diagram of an artificial intelligence agent according to embodiments of the present disclosure.

In an embodiment of the present disclosure, as shown in FIG. 6, an AI agent 600 may include an input module 610, a processing module 620, and an output module 630.

The input module 610 is configured to receive an input information.

The processing module 620 is configured to determine a target task based on the input information received by the input module, determine a large model based on the target task, and perform the agent-based method for generating corpus data provided in embodiments of the present disclosure by invoking the large model, to obtain an output information.

The output module 630 is configured to output the output information obtained by the processing module.

According to embodiments of the present disclosure, the input module 610 is responsible for receiving or perceiving information such as queries, requests, instructions, signals, or data from the outside (for example, users or the external environment) and converting the information into a format that the AI agent 600 may understand and process. The input module 610 is a primary link for the AI agent 600 to interact with the outside world, enabling the AI agent 600 to efficiently and accurately obtain necessary “sensory” information from the outside world and respond to the information.

In an example, the input module 610 may input the target task rule, the page to be processed, etc., described above.

In an example, the processing module 620 is a core support for the AI agent 600's ability to handle complex tasks. The processing module 620 may perform the agent-based method for generating corpus data described above.

In an example, the performance of the processing module 620 may be closely related to the large model on which the AI agent 600 is based. To give full play to the capabilities of the large model, the internal structure of the processing module 620 may be designed to be highly configurable and extensible to meet various types of tasks and requirements in real scenarios.

In an example, after the AI agent 600 acquires the page to be processed and the target task rule, the processing module 620 may process the page to be processed and the target task rule by using a large model to obtain an item response information, and transmit the item response information to the output module 630.

It may be understood that although large language models have excellent language understanding and generation capabilities, the tasks they can accomplish without the aid of any tools are quite limited, just like humans. When the AI agent 600 is endowed with the capability to invoke tools, it becomes able to execute tasks such as performing mathematical operations using a calculator, performing data analysis through Python, or performing weather forecasts by means of a search engine.

In an example, the output module 630 may output the item response information or target corpus data described above.

The AI agent 600 according to embodiments of the present disclosure may enhance the level of intelligence in a simple and effective manner and improve flexibility and generality.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor; where the memory stores instructions executable by the at least one processor, and the instructions are configured to, when executed by the at least one processor, cause the at least one processor to perform the method described above.

According to embodiments of the present disclosure, a non-transitory computer-readable storage medium having computer instructions therein is provided, where the computer instructions are configured to cause a computer to perform the method described above.

According to embodiments of the present disclosure, a computer program product including a computer program is provided, where the computer program is configured to, when executed by a processor, implement the method described above.

FIG. 7 shows a schematic block diagram of an exemplary electronic device that may be used to implement the agent-based method for generating corpus data according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, the electronic device 700 includes a computing unit 701 which may perform various appropriate actions and processes according to a computer program stored in a read only memory (ROM) 702 or a computer program loaded from a storage unit 708 into a random access memory (RAM) 703. In the RAM 703, various programs and data necessary for an operation of the electronic device 700 may also be stored. The computing unit 701, the ROM 702 and the RAM 703 are connected to each other through a bus 704. An input/output (I/O) interface 705 is also connected to the bus 704.

A plurality of components in the electronic device 700 are connected to the input/output (I/O) interface 705, including: an input unit 706, such as a keyboard, or a mouse; an output unit 707, such as displays or speakers of various types; a storage unit 708, such as a disk, or an optical disc; and a communication unit 709, such as a network card, a modem, or a wireless communication transceiver. The communication unit 709 allows the electronic device 700 to exchange information/data with other devices through a computer network such as Internet and/or various telecommunication networks.

The computing unit 701 may be various general-purpose and/or dedicated processing assemblies having processing and computing capabilities. Some examples of the computing units 701 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 701 executes various methods and processes described above, such as the agent-based method for generating corpus data. For example, in some embodiments, the agent-based method for generating corpus data may be implemented as a computer software program which is tangibly embodied in a machine-readable medium, such as the storage unit 708. In some embodiments, the computer program may be partially or entirely loaded and/or installed in the electronic device 700 via the ROM 702 and/or the communication unit 709. The computer program, when loaded in the RAM 703 and executed by the computing unit 701, may execute one or more steps in the agent-based method for generating corpus data described above. Alternatively, in other embodiments, the computing unit 701 may be used to perform the agent-based method for generating corpus data by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the data processing method of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. An agent-based method for generating corpus data, comprising:
acquiring a target task rule related to a page to be processed, wherein a semantic dependency relationship in the target task rule represents a semantic understanding logic among a plurality of item components in the page to be processed;
executing a target task for the plurality of item components based on the semantic dependency relationship by using a designated agent according to the target task rule, and outputting an item response information; and
generating target corpus data according to the item response information and item contents in the item components.

2. The method of claim 1, wherein the target task rule is determined by:
performing semantic understanding on a response requirement information to obtain a response requirement condition, wherein the response requirement information describes a requirement intent for responding to the item components; and
performing semantic fusion, by using a large model, on the response requirement condition and the respective item contents of the plurality of item components, to obtain the target task rule comprising the semantic dependency relationship.

3. The method of claim 2, wherein the performing semantic fusion, by using a large model, on the response requirement condition and the respective item contents of the plurality of item components comprises:
performing semantic fusion, by using the large model, on the response requirement condition, the respective item contents of the plurality of item components, and a positional relationship among the plurality of item contents, to obtain the semantic dependency relationship, wherein the positional relationship is determined based on a page layout of the plurality of item contents in the page to be processed.

4. The method of claim 1, wherein the executing a target task for the plurality of item components based on the semantic dependency relationship by using a designated agent according to the target task rule comprises:
performing task orchestration on a target item component based on the semantic dependency relationship by using the designated agent to obtain a content understanding path, wherein the content understanding path represents a semantic understanding sequence for a plurality of target item contents related to the target item component; and
performing semantic understanding on the plurality of target item contents based on the content understanding path by using the designated agent according to an item response rule in the target task rule, and outputting an item response information related to the target item component.

5. The method of claim 4, wherein the performing semantic understanding on the plurality of target item contents based on the content understanding path by using the designated agent according to an item response rule in the target task rule comprises:
executing a semantic understanding task for a first target content among the plurality of target item contents based on the content understanding path by using the designated agent, and outputting a first execution result; and
performing semantic understanding on a second target content associated with the first target content based on the content understanding path by using the designated agent according to the first execution result, and outputting a second execution result, wherein the item response information is determined based on the first execution result and the second execution result.

6. The method of claim 1, wherein the generating target corpus data according to the item response information and item contents in the item components comprises:
annotating item corpus in the item content based on an evaluation response information to obtain first target corpus data; and
annotating a text response information based on a text requirement content in a text generation item component to obtain second target corpus data.

7. The method of claim 1, further comprising:
in response to an interactive operation performed on a first response information in the item response information, updating the first response information to obtain an updated first response information;
determining a second response information associated with the first response information from a plurality of item response information based on the semantic dependency relationship; and
updating the second response information according to the updated first response information to obtain an updated second response information.

8. The method of claim 1, wherein the item component comprises a page component related to at least one selected from: judgment item, selection item, ranking item, or text generation item.

9. An artificial intelligence agent, configured to perform the method of claim 1.

10. An electronic device, comprising:
at least one processor; and
a memory communicatively connected to the at least one processor, wherein the memory stores instructions executable by the at least one processor, and the instructions are configured to, when executed by the at least one processor, cause the at least one processor to:
acquire a target task rule related to a page to be processed, wherein a semantic dependency relationship in the target task rule represents a semantic understanding logic among a plurality of item components in the page to be processed;
execute a target task for the plurality of item components based on the semantic dependency relationship by using a designated agent according to the target task rule, and output an item response information; and
generate target corpus data according to the item response information and item contents in the item components.

11. The electronic device of claim 10, wherein the target task rule is determined by:
performing semantic understanding on a response requirement information to obtain a response requirement condition, wherein the response requirement information describes a requirement intent for responding to the item components; and
performing semantic fusion, by using a large model, on the response requirement condition and the respective item contents of the plurality of item components, to obtain the target task rule comprising the semantic dependency relationship.

12. The electronic device of claim 11, wherein the at least one processor is further configured to:
perform semantic fusion, by using the large model, on the response requirement condition, the respective item contents of the plurality of item components, and a positional relationship among the plurality of item contents, to obtain the semantic dependency relationship, wherein the positional relationship is determined based on a page layout of the plurality of item contents in the page to be processed.

13. The electronic device of claim 10, wherein the at least one processor is further configured to:
perform task orchestration on a target item component based on the semantic dependency relationship by using the designated agent to obtain a content understanding path, wherein the content understanding path represents a semantic understanding sequence for a plurality of target item contents related to the target item component; and
perform semantic understanding on the plurality of target item contents based on the content understanding path by using the designated agent according to an item response rule in the target task rule, and output an item response information related to the target item component.

14. The electronic device of claim 13, wherein the at least one processor is further configured to:
execute a semantic understanding task for a first target content among the plurality of target item contents based on the content understanding path by using the designated agent, and output a first execution result; and
perform semantic understanding on a second target content associated with the first target content based on the content understanding path by using the designated agent according to the first execution result, and output a second execution result, wherein the item response information is determined based on the first execution result and the second execution result.

15. The electronic device of claim 10, wherein the at least one processor is further configured to:
annotate item corpus in the item content based on an evaluation response information to obtain first target corpus data; and
annotate a text response information based on a text requirement content in a text generation item component to obtain second target corpus data.

16. The electronic device of claim 10, wherein the at least one processor is further configured to:
in response to an interactive operation performed on a first response information in the item response information, update the first response information to obtain an updated first response information;
determine a second response information associated with the first response information from a plurality of item response information based on the semantic dependency relationship; and
update the second response information according to the updated first response information to obtain an updated second response information.

17. The electronic device of claim 10, wherein the item component comprises a page component related to at least one selected from: judgment item, selection item, ranking item, or text generation item.

18. A non-transitory computer-readable storage medium having computer instructions therein, wherein the computer instructions, when executed by a processor, are configured to cause a computer to:
acquire a target task rule related to a page to be processed, wherein a semantic dependency relationship in the target task rule represents a semantic understanding logic among a plurality of item components in the page to be processed;
execute a target task for the plurality of item components based on the semantic dependency relationship by using a designated agent according to the target task rule, and output an item response information; and
generate target corpus data according to the item response information and item contents in the item components.

19. The non-transitory computer-readable storage medium of claim 18, wherein the target task rule is determined by:
performing semantic understanding on a response requirement information to obtain a response requirement condition, wherein the response requirement information describes a requirement intent for responding to the item components; and
performing semantic fusion, by using a large model, on the response requirement condition and the respective item contents of the plurality of item components, to obtain the target task rule comprising the semantic dependency relationship.

20. The non-transitory computer-readable storage medium of claim 19, wherein the computer instructions are configured to cause the computer to:
perform semantic fusion, by using the large model, on the response requirement condition, the respective item contents of the plurality of item components, and a positional relationship among the plurality of item contents, to obtain the semantic dependency relationship, wherein the positional relationship is determined based on a page layout of the plurality of item contents in the page to be processed.
